(19) United States
(12) Patent Application Publication
(10) Pub. No.: US 2011/0223096 A1
(43) Pub. Date: Sep. 15, 2011

(54) CATALYST FOR OXIDATION REACTIONS IN THE PRESENCE OF HYDROGEN CHLORIDE AND/OR CHLORINE AND METHOD FOR THE PRODUCTION THEREOF, AND THE USE THEREOF

(75) Inventors: Aurel Wolf, Wulfrath (DE); Leslaw Mleczko, Dormagen (DE); Jens Abmann, Hilden (DE); Frank Rauscher, Koln (DE)

(73) Assignee: Bayer Technology Services GMBH, Leverkusen (DE)

(21) Appl. No.: 13/128,447

(22) PCT Filed: Nov. 24, 2009
(86) PCT No.: PCT/EP09/08342

§ 371 Date: May 11, 2011

(30) Foreign Application Priority Data
Dec. 3, 2008 (DE) 102008060259.0

(51) Int. Cl. C01B 7/04; B01J 21/06; B01J 35/02; B01J 37/025; B01J 31/20; B01J 27/24; B01J 31/22; B01J 35/08; B82Y 30/00

(52) U.S. Cl. 423/507; 502/349; 502/350; 502/325; 502/174; 502/200; 502/167; 502/8; 977/902

(57) ABSTRACT

Thermally stable catalyst for heterogeneously catalyzed oxidation in the presence of hydrogen chloride and/or chlorine, comprising nanoparticulate core of a ruthenium compound with surrounding gas- and liquid-pervious shell of zirconium oxide or titanium oxide.

The invention relates to a novel thermally stable catalyst, to a process for preparation thereof and to the use thereof in processes for heterogeneously catalyzed oxidation of hydrogen chloride to chlorine.

A reaction of great industrial interest is the process for catalytic hydrogen chloride oxidation with oxygen, developed by Deacon in 1868.

In the past, the Deacon process was very much forced into the background by chloralkali electrolysis. Virtually all chlorine was produced by electrolysis of aqueous sodium chloride solutions.

However, especially with regard to the global growth in demand for chlorine and in view of the lesser growth in demand for sodium hydroxide solution, which constitutes the significant by-product of chloralkali electrolysis, the abovementioned Deacon process is of high economic interest.

This development is to the benefit of the process for preparing chlorine by catalytic oxidation of hydrogen chloride, which is decoupled from the production of sodium hydroxide solution. In addition, hydrogen chloride is obtained as a coproduct in large amounts, for example, in phosgenation reactions, for instance in isocyanate preparation.

The catalytic oxidation of hydrogen chloride to chlorine is an equilibrium reaction. With increasing temperature, the equilibrium position shifts to disfavor the desired chlorine end product.

The catalysts used at present for catalytic oxidation of chlorine in connection with processes related to the abovementioned Deacon process are therefore based on catalyst components which have a high activity for the conversion of hydrogen chloride to chlorine even at low temperatures.

For instance, WO 2007/134726 discloses that catalysts based on ruthenium, palladium, platinum, osmium, iridium, silver, copper or rhenium are suitable for this purpose. The process according to WO 2007/134726 is preferably performed in temperature ranges from 200° C. to 450° C.

WO 2007/134726 does not disclose that one reason for the aforementioned preferred temperatures at which the process is operated is the adverse effects on the catalyst at higher temperatures. These adverse effects are based on the commonly known property of transition metals, for instance ruthenium, to be converted to a volatile form and/or to be sintered at elevated temperatures as a result of oxidation.

The possibility of further oxidation especially of ruthenium, to give a volatile compound is described, for instance, by Backmann et al. in “On the transport and speciation of ruthenium in high temperature oxidising conditions” (Radiochim. Acta, 2005 93: 297-304). It is also disclosed therein that all oxides of ruthenium apart from the Ru and RuO₂ phases are volatile compounds which are formed in relatively large amounts within minutes at temperatures above 800° C. At temperatures of up to 450° C., as disclosed in WO 2007/134726, it can therefore be assumed that the formation of the volatile ruthenium species likewise occurs, though not at the same rate. In industrial processes in which such processes are operated, however, operating times of months up to years are quite common, and so a noticeable effect can be assumed.

As a result of this, the catalytic oxidation of hydrogen chloride to chlorine would no longer be able to achieve a sufficient conversion after a short time as a result of the loss of catalyst.

The possibility of sintering of such catalysts is likewise common knowledge and is caused by the mobility of molecules at relatively high temperatures, as described, for instance, in Ertl et al., Handbook of Heterogeneous Catalysis, 1997, Vol. 3, 1276-1278. Such sintering results in a decrease in the catalytically active metal surface area, and hence the catalytic activity of the catalyst simultaneously declines significantly.

Standard catalysts as disclosed, for instance, in WO 2007/134726, are thus disadvantageous since they cannot be used at relatively high temperatures because there would either be a risk of loss of catalyst as a result of conversion to a volatile species, or because the catalyst would sinter and hence no longer be available in sufficiently catalytically active form.

Since the catalytic oxidation of hydrogen chloride to chlorine is, however, a strongly exothermic reaction, a temperature increase should either always be avoided in an operationally complex manner, or the catalyst has to be renewed at regular intervals.

An alternative catalyst and a process for preparation thereof, said catalyst no longer having the aforementioned disadvantages, is disclosed in German patent application DE 10 2007 047 434.4.

The catalyst disclosed in DE 10 2007 047 434.4 consists of nanoparticulate palladium around which a porous zirconium layer is present. The catalyst disclosed therein is intended for use in hydrogenations and dehydrogenations. It is not disclosed that the catalyst would be usable for the heterogeneously catalyzed oxidation of hydrogen chloride to chlorine.

The process disclosed in DE 10 2007 047 434.4 for preparing the catalyst comprises the steps of preparing palladium nanoparticles, coating the palladium nanoparticles prepared with Sift, applying a porous zirconium oxide layer to the Pd/SiO₂ spheres and extractively washing the SiO₂ layer with a base. Use of ruthenium or ruthenium compounds in the process of DE 10 2007 047 434.4 is not disclosed.

In other technical fields, the possibility in principle of coating nanoparticles is known, but such coatings are disclosed here around semiconductive particles.

For instance, Darbandi et al. disclose, in “Single Qunatum Dots in Silica Spheres by Microemulsion Synthesis”, Chem. Mater. 2005, 17: 5720-5725, that silica layers can be formed around cadmium selenide/zinc sulfide nanoparticles, by applying tetradecyl orthosilicate (TEOS) to the nanoparticles in an emulsion process, and by then polymerizing the TEOS on the surface of the nanoparticles by means of addition of aqueous ammonia.

It is not disclosed here that the silicate layer thus formed is dissolved, or that a further zirconium oxide layer is applied to this silicate layer.

A transfer of this preparation method of coated nanoparticles to catalyst materials is disclosed by Naito et al. in “Preparation of hollow silica-Rh, -Ir, and Rh/Ir-bimetallic nanocomposites by reverse micelle technique and their unique adsorption and catalytic behavior”, Scientific Bases for the Preparation of Heterogeneous Catalysts, ed. E. M. Gaigneaux, 2006: 63-70.

This discloses the preparation of silicate-coated nanoparticles in emulsions similar to those from Darbandi et al., the nanoparticles being formed and coated in the same solution. Again, TEOS is polymerized on the surface of the nanoparticles by means of addition of aqueous ammonia to give silicate layers.

According to the disclosure by Naito et al., application to ruthenium nanoparticles obtained from the crystallization of ruthenium chloride gives non-hollow (nh) particles which consist of a ruthenium core and a directly adjoining silicate layer. In the case of rhenium nanoparticles, for instance, obtained from the crystallization of amino rhenium chloride, in contrast, hollow (h) particles are obtained, which consist of a nanoparticle of rhenium, and a surrounding silicate layer, in which the nanoparticle can move freely. In other words, the rhenium nanoparticle is neither fixed neither mechanically nor by a chemical bond at a fixed site within the hollow overall particle disclosed.

It is further disclosed that the nanoparticles prepared by means of the process according to Naito et al. are suitable as catalysts, and that these particles, according to whether they are hollow or non-hollow particles, feature different adsorption properties with regard to the gases hydrogen and carbon monoxide. Naito et al. further discloses that these properties of the resulting catalyst materials for hydrogenations or dehydrogenations result in particularly advantageous properties.

Naito et al. also do not disclose that the silicate layer is dissolved, or a further zirconium oxide layer is applied to this silicate layer. Moreover, Naito et al. do not disclose use of the catalysts for oxidation reactions, and more particularly not for the oxidation of hydrogen chloride to chlorine. Since the adsorption behavior of molecules on catalyst surfaces also depends on the radii of the atoms of the molecules, and since chlorine atoms in particular have a significantly greater atomic radius than the hydrogen atoms and carbon monoxide molecules disclosed in Naito et al., applicability of the results to the oxidation of hydrogen chloride to chlorine is questionable. Naito et al. likewise do not give any indication to better stability of the catalysts obtained.

Proceeding from the prior art, it is thus still a problem to provide catalysts, and processes for preparation thereof, which have the required thermal stability even in the presence of hydrogen chloride and/or chlorine, without restricting the activity of these catalysts.

It has now been found that, surprisingly, a catalyst for heterogeneously catalyzed oxidation in the presence of hydrogen chloride and/or chlorine, characterized in that it comprises a nanoparticulate core consisting of a ruthenium compound with a surrounding gas- and liquid-pervious shell of zirconium oxide or titanium oxide, is capable of solving this problem.

The term “nanoparticulate” in the context of the present invention refers to particles having a mean of a particle size distribution (d₅₀) of 0.1 to 100 nm. Such particles preferably have a mean of a particle size distribution (d₅₀) of 0.3 to 70 nm, more preferably of 0.5 to 40 nm.

“Ruthenium compound” in the context of the present invention refers to the substances selected from the list consisting of ruthenium, ruthenium oxides and ruthenium oxychlorides.

Preferred ruthenium compounds are ruthenium oxides and ruthenium oxychlorides.

The aforementioned core, consisting of a nanoparticulate ruthenium compound, is typically present in a shell of zirconium oxide or titanium oxide, the internal diameter of which is greater than the external diameter of the nanoparticulate core, consisting of a ruthenium compound.

It follows from this that typically hollow shells of zirconium oxide or titanium oxide are present, in which the nanoparticulate core consisting of a ruthenium compound is freely mobile. In other words, the nanoparticulate core is fixed neither mechanically nor by a chemical bond at a fixed site within the hollow shell.

Such an inventive catalyst is particularly advantageous because the shell of zirconium oxide or titanium oxide prevents sintering of the nanoparticulate core consisting of a ruthenium compound with other nanoparticulate cores consisting of a ruthenium compound, but at the same time the entire surface area of the nanoparticulate core consisting of a ruthenium compound is available as an absorption surface for the compound to be oxidized in the sense of a heterogeneously catalyzed oxidation, without active sites of the nanoparticulate core consisting of a ruthenium compound not being accessible as a result of binding sites to the shell material. Thus, all active sites of the core consisting of a nanoparticulate ruthenium compound are fully accessible.

Without being bound to a theory, such a catalyst also prevents or delays the above-discussed conversion of the ruthenium to volatile components, since an increased partial pressure of such volatile components arises within the shell of zirconium oxide or titanium oxide as soon as they are formed. This leads at least to inhibition or prevention of further formation of such volatile components, and so the inventive catalyst is notable for particularly advantageous stability at high temperatures, as exist, for instance, in the heterogeneously catalyzed oxidation of hydrogen chloride to chlorine. The aforementioned mass transfer resistances, however, frequently differ as a result of the once again vast differences in molecular radii of the volatile components relative to those of the reactants, for instance of the heterogeneously catalyzed oxidation of hydrogen chloride to chlorine, and so mass transfer resistance to these through the shell of zirconium oxide or titanium oxide has no significant adverse effect on the conversion, for instance to chlorine.

To clarify the above statement, reference is made to the commonly known atomic radii of the atoms involved in such oxidation reactions. For instance, ruthenium has an atomic radius of 130 pm and oxygen an atomic radius of 60 pm, and so an approximate molecular radius, for example of the volatile ruthenium tetroxide component, assuming a tetrahedral arrangement of oxygen around the ruthenium atom, of at least 250 pm can be assumed. In contrast, chlorine, for example, has an atomic radius of only about 100 pm.

The external diameter of the shell of titanium oxide or zirconium oxide is typically from 10 to 1000 nm, preferably from 15 to 500 nm and more preferably from 20 to 300 nm, and the nanoparticulate core consisting of a ruthenium compound has a much smaller diameter than that external diameter.

The layer thickness of the shell is typically within the range from 10 to 100 nm, preferably from 15 to 80 nm, more preferably from 15 to 40 nm.

The layer thickness of the shell of zirconium oxide or titanium oxide should not be too low in order not to impair the physical stability thereof, but should not be significantly greater than the above-specified maximum layer thicknesses in order not to make the mass transfer limitation appear significant for the reactants of the heterogeneously catalyzed oxidation reaction, for instance of hydrogen chloride to give chlorine.

The shell of titanium oxide or zirconium oxide according to the inventive catalysts in the range from 10 to 100 nm, preferably from 15 to 80 nm and more preferably from 15 to 40 nm is particularly advantageous because it has no or barely any mass transfer resistances as a result of the much smaller thickness in contrast to the shells of silicates used according to the prior art.

In addition, the inventive shell of titanium oxide or zirconium oxide exhibits a lower tendency to reaction with hydrogen chloride and hence to formation of volatile chlorides.

The heterogeneously catalyzed oxidation in the presence of hydrogen chloride and/or chlorine is thus preferably the heterogeneously catalyzed oxidation of hydrogen chloride to chlorine, by the process disclosed in this invention.

In a preferred embodiment of the present invention, the catalyst is thus one for the heterogeneously catalyzed oxidation of hydrogen chloride to chlorine, characterized in that it comprises a nanoparticulate core consisting of a ruthenium compound with a surrounding gas- and liquid-pervious shell of zirconium oxide or titanium oxide.

In addition, there is also a lesser tendency to reaction with organic substances which are frequently present in small proportions in process gases comprising the reactants of the heterogeneously catalyzed oxidation of hydrogen chloride to chlorine. The reactions which take place at these high temperatures can lead to damage to the catalyst, for instance as a result of occlusion of the pores of the shell via coking, or even to loss of the shell, which is less probable with the inventive shell materials of zirconium oxide or titanium oxide.

The inventive catalyst may also have a multitude of nanoparticulate cores consisting of a ruthenium compound each surrounded by gas- and liquid-pervious shells of zirconium oxide or titanium oxide. For instance, the catalyst may be present in the form of a shaped body comprising many of the aforementioned nanoparticulate cores consisting of a ruthenium compound surrounded by gas- and liquid-pervious shells of zirconium oxide or titanium oxide.

The present invention further provides a process for preparing a catalyst for heterogeneously catalyzed oxidation reactions in the presence of hydrogen chloride and/or chlorine, at least comprising the steps of:
a) preparing nanoparticulate cores consisting of a ruthenium compound,
b) coating the nanoparticulate ruthenium cores prepared from step a) with a silicate layer,
c) further coating the particles obtained from step b) with a shell of porous zirconium oxide or titanium oxide,
d) removing the silicate layer from the particles obtained from step c) using an alkali.

For the preparation of the nanoparticulate cores consisting of a ruthenium compound in step a) of the process according to the invention, ruthenium compounds soluble in alcohols are typically used, for example those selected from the list consisting of ruthenium oxides, ruthenium-carbonyl complexes, ruthenium salts of inorganic acids, ruthenium-nitrosyl complexes, ruthenium-amine complexes and the mixed forms.

Nonexclusive examples of ruthenium carbonyl complexes are, for instance, those selected from the list consisting of Ru(CO)₅, Ru₂(CO)₉ and Ru₃(CO)₁₂.

Nonexclusive examples of ruthenium salts of inorganic acids are, for instance, those selected from the list consisting of ruthenium chloride, ruthenium bromide, sodium chlororuthenate (Na₃[RuCl₆]), potassium chlororuthenate hydrate K₂-[RuCl₂(H₂O)₄] and ruthenium oxychloride (RuOCl₂, Ru₂OCl₄).

Nonexclusive examples of ruthenium-nitrosyl complexes are, for instance, those selected from the list consisting of K₂-[RuCl₅(NO)] and [Ru(NH₃)₅(NO)]Cl₃.

Nonexclusive examples of ruthenium-amine complexes are, for instance, those selected from the list consisting of hexaammineruthenium chloride ([Ru(NH₃)₆]Cl₂, [Ru(NH₃)₆]Cl₃) and pentaamminechlororuthenium chloride ([Ru(NH₃)₅Cl]Cl₂).

The inventive preparation of nanoparticulate cores consisting of a ruthenium compound in step a) of the process according to the invention is effected typically by reducing the soluble ruthenium compound.

Such a reduction can be performed chemically and/or electrochemically. It is preferably effected chemically.

When the reduction is effected chemically, preference is given to using reducing compounds with “active hydrogen”, for example hydrogen, methanol, ethanol, propanol and longer-chain alcohols, ethanediol, glycol, 1,3-propanediol, glycerol and polyols.

Particular preference is given to using methanol, ethanol, propanol and polyols to reduce the soluble ruthenium compound.

Such reducing compounds with “active hydrogen” in the particularly preferred reduction are particularly advantageous because they act both as solvents of the soluble ruthenium compound and as reducing agents.

The ratio of soluble ruthenium compound and reducing agent can be used to influence the particle size and particle size distribution.

The reduction of the soluble ruthenium compound is performed typically at temperatures of 0 to 250° C., preferably of 10 to 200° C. and more preferably at temperatures of 15 to 150° C.

The reduction of the soluble ruthenium compound can take place either with or without a surface-active stabilizing agent (also known as stabilizers or surfactants).

Preferably, however, the preparation of nanoparticulate cores consisting of a ruthenium compound in step a) of the process according to the invention, for the purposes of the aforementioned reduction, takes place using stabilizers which prevent the agglomeration of the nanoparticulate cores formed, consisting of a ruthenium compound, and allow controlled adjustment of the particle size and morphology of the nanoparticulate cores consisting of a ruthenium compound.

For this purpose, preference is given to using stabilizers, for example, polyvinylpyrrolidone (PVP), alcohol polyethylene glycol ethers (e.g. Marlipal®), polyacrylates, polyols, long-chain n-alkyl acids, long-chain n-alkyl esters, long-chain n-alkyl alcohols and ionic surfactants (e.g. AOT, CTAB).

Soluble ruthenium compound and stabilizer can be mixed with the reducing compound semibatchwise or continuously.

It is effective in the liquid phase preferably using suitable thermostated reactors (e.g. stirred tank reactor, flow reactor with static mixing internals, microreactors).

In addition, the aforementioned reactants for the reductive preparation of nanoparticulate cores consisting of a ruthenium compound can also be dissolved in the droplet volume of liquid-liquid emulsions (e.g. miniemulsions or microemulsions) and then reacted via the mixing of the two emulsion solutions.

The nanoparticulate cores obtained by one of the methods described, consisting of a ruthenium compound, possess an advantageous narrow distribution of the particle size, where the mean of the particle size distribution (d₅₀) is advantageously obtained within the range of the size ranges preferred for the inventive catalyst.

The use of the abovementioned stabilizers allows the nanoparticulate cores consisting of a ruthenium compound, after removal from the reaction solution (for example by ultrafiltration or by centrifugation) to be redispersed in a suitable solvent.

Preference is given to using a solvent suitable for coating with a silicate layer in step b) of the process according to the invention. Such solvents are, for instance, those selected from the list comprising water, methanol, ethanol and further alcohols.

The coating with a silicate layer in step b) of the process according to the invention can be effected by hydrolysis or precipitative application of a silicate layer precursor.

Preferred silicate layer precursors are those selected from the list consisting of tetramethyl orthosilicate (TMOS), tetraethyl orthosilicate (TEOS), tetrapropyl orthosilicate (TPOS) and similar orthosilicates.

The coating in step b) of the process according to the invention is effected preferably by hydrolysis of at least one of the aforementioned silicate layer precursors. It is more preferably effected by hydrolysis of at least one of the aforementioned silicate layer precursors in a liquid comprising ammonia solution. As well as ammonia solution, the liquid may also comprise methanol, ethanol, propanol, isopropanol, butanol, 1,3-propanediol and/or glycerol.

The hydrolysis can be performed at room temperature (20° C.) up to the boiling temperature of the hydrolysis liquid. The hydrolysis is preferably performed at room temperature.

The diameter of the particles obtained from the coating in step b) of the process according to the invention is typically from 10 to 1000 nm, preferably from 15 to 500 nm and more preferably from 20 to 300 nm.

The particles thus obtained from step b) of the process according to the invention thus advantageously have an external diameter which corresponds to the preferred internal diameters of the shells of zirconium oxide or titanium oxide of the inventive catalysts.

For further processing, the particles obtained from step b) of the process according to the invention can be purified by cycles of removal, by sedimentation for example, centrifugation or evaporative concentration, and washing with washing liquids.

The further coating in step c) of the process according to the invention is effected typically by hydrolysis or precipitative application of a zirconium oxide shell precursor or of a titanium oxide shell precursor.

Preferred zirconium oxide shell precursors are zirconium alkoxides or zirconium halides.

Preferred or titanium oxide shell precursors are titanium alkoxides or titanium halides.

Preferred zirconium alkoxides are those selected from the list consisting of zirconium methoxide, zirconium ethoxide, zirconium n-propoxide and zirconium n-butoxide.

Preferred titanium alkoxides are those selected from the list consisting of titanium methoxide, titanium ethoxide, titanium n-propoxide, titanium t-butoxide and titanium n-butoxide.

Preferred zirconium halides are those selected from the list consisting of zirconium chloride (ZrCl₄), zirconium bromide (ZrBr₄) and zirconium iodide (ZrI₄).

Preferred titanium halides are those selected from the list consisting of titanium chloride (TiCl₄), titanium bromide (TiBr₄) and titanium iodide (TiI₄).

The further coating in step c) of the process according to the invention is effected preferably by hydrolysis of at least one of the aforementioned zirconium oxide shell precursors or titanium oxide shell precursors.

The further coating in step c) of the process according to the invention is more preferably effected by hydrolysis of at least one of the aforementioned zirconium oxide shell precursors or titanium oxide shell precursors in a liquid comprising water, methanol, ethanol, propanol and/or glycerol.

The further coating in the form of a hydrolysis in step c) of the process according to the invention is very preferably performed in the presence of stabilizers, as have already been disclosed in connection with step a) of the process according to the invention.

The further coating in step c) of the process according to the invention can be performed at temperatures of 0 to 200° C. It is preferably performed at temperatures of 10 to 100° C.

The amount of zirconium oxide shell precursor or titanium oxide shell precursor can be used advantageously to adjust the layer thickness of the shell of zirconium oxide or titanium oxide to the values disclosed in connection with the inventive catalyst.

In a preferred development of step c) of the process according to the invention, the further coating is followed by performance of “aging” of the particles obtained over a period of one hour to five days.

“Aging” in connection with the present invention means that the suspension of particles obtained from step c) of the process according to the invention is left to stand in a solvent while stirring for the aforementioned period at room temperature (20° C.) and ambient pressure (1013 hPa).

Before step d) of the process according to the invention is performed, the particles obtained from step c) of the invention or the preferred development thereof are removed from the solvent by customary technical methods, such as centrifugation, sedimentation, filtration, etc., dried and then calcined.

The drying can be effected separately from the calcining in two separate steps, or by increasing the temperature stepwise from room temperature to calcination temperature. The drying and the calcining accordingly differ only by the temperature at which the individual steps are executed.

Drying in connection with the present invention is understood to be a step which is executed within a temperature range from 100 to 250° C., while a step which is performed at temperatures of 250 to 900° C. is referred to as calcination.

Such a calcination is advantageous because the zirconium oxide shell precursors or titanium oxide shell precursors which may still be present are converted to the desired oxidic form which has the desired properties in the inventive catalyst.

The silicate layer is removed in step d) of the process according to the invention by dissolution of the silicate layer with an alkali.

Suitable alkalis are all alkali metal and alkaline earth metal hydroxides, for example solutions of NaOH, KOH, LiOH, Mg(OH)₂, Ca(OH)₂ etc.

The solution may be aqueous or alcoholic.

The silicate layer is removed in step d) of the process according to the invention typically at temperatures of 0 to 250° C. and preferably at temperatures of 10 to 100° C.

The action of the alkali proceeds until complete dissolution of the silicate layer, which can be detected by commonly known methods. One such method is, for instance, transmission electron microscopy on samples of particles from the solution.

This complete dissolution typically requires action of the alkali over a period of 2 to 24 hours. Preference is also given to multiple performance of step d) with fresh alkali.

After step d) of the process according to the invention, the catalyst particles obtained are typically removed and dried.

The removal can again be effected by commonly known methods. Preference is given, however, to the methods of centrifugation, filtration or sedimentation.

The drying is preferably performed in an air stream. Alternatively, the drying can also be effected under protective gas or hydrogen.

In a preferred development of the process according to the invention, the catalyst present in powder form at first from step d) of the process according to the invention is processed further to shaped bodies.

Shaped bodies are preferably produced in the form of spheres, rings, stars (trilobes or tetralobes), tablets, cylinders or wagonwheels.

The dimensions of these shaped bodies are preferably in the range from 0.2 to 10 mm, more preferably from 0.5 to 7 mm.

The further processing is effected by known processes such as pressing, spray drying and extrusion, especially in the presence of a binder.

Alternatively, the catalyst present in powder form at first from step d) of the process according to the invention can be applied as a washcoat to structured catalysts (monoliths).

The invention further provides for the use of the inventive catalyst or of one of the preferred embodiments and developments thereof, or for the use of the substances prepared by the process according to the invention, as a catalyst for the heterogeneously catalyzed oxidation of hydrogen chloride to chlorine.

The present invention finally provides a process for preparing chlorine from hydrogen chloride, characterized in that it is performed in the presence of a catalyst comprising a nanoparticulate core consisting of a ruthenium compound with a surrounding gas- and liquid-pervious shell of zirconium oxide or titanium oxide.

In preferred embodiments, the process is performed at temperatures above 250° C., more preferably above 350° C., most preferably above 450° C.

By virtue of the inventive novel catalyst, permanent operation of such a process for a long period is possible for the first time, without any occurrence of sintering or of serious loss of catalyst material.

The invention is illustrated hereinafter with reference to a figure, without thereby restricting it thereto.

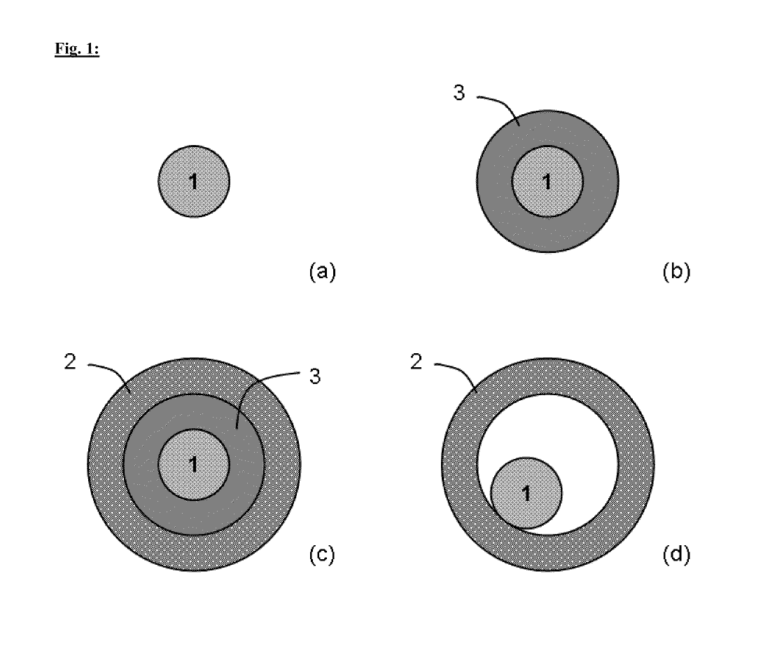

FIG. 1 shows the schematic structure of an inventive catalyst particle (d), consisting of a nanoparticulate core of a ruthenium compound 1 and of a shell of zirconium oxide 2, while a cavity exists between the two, since the external diameter of the nanoparticulate core of a ruthenium compound 1 is smaller than the internal diameter of the shell of zirconium oxide 2. In addition, FIG. 1 shows a schematic of the intermediate steps of the process according to the invention. At first, a nanoparticulate core of a ruthenium compound 1 is present in (a), which is then coated (b) with a silicate layer 3 in step b) of the process according to the invention. A shell of zirconium oxide 2 is formed around the silicate layer 3, such that a particle (c) consisting of a nanoparticulate core of a ruthenium compound 1, of a first silicate shell 3 and of a further shell of zirconium oxide 2 is formed at first. Subsequently, the dissolution of the silicate shell 3 affords the inventive catalyst particle (d).

1. A catalyst for heterogeneously catalyzed oxidation in the presence of hydrogen chloride and/or chlorine, comprising a nanoparticulate core consisting of a ruthenium compound with a surrounding gas- and liquid-pervious shell of zirconium oxide or titanium oxide.

2. The catalyst as claimed in claim 1, wherein the nanoparticulate core consisting of a ruthenium compound has a particle size distribution with a mean (d₅₀) of 0.1 to 100 nm.

3. The catalyst as claimed in claim 1, wherein the internal diameter of the shell of zirconium oxide or titanium oxide is greater than the external diameter of the nanoparticulate ruthenium core.

4. The catalyst as claimed in claim 3, wherein the internal diameter of the shell of zirconium oxide or titanium oxide is from 10 to 1000 nm.

5. The catalyst as claimed in claim 1, wherein the shell of zirconium oxide or titanium oxide has a layer thickness within the range from 10 to 100 nm.

6. The catalyst as claimed in claim 1 in the form of shaped bodies comprising a plurality of said nanoparticulate ruthenium cores surrounded by gas- and liquid-pervious shells of zirconium oxide or titanium oxide.

7. A process for preparing a catalyst for heterogeneously catalyzed oxidation reactions in the presence of hydrogen chloride and/or chlorine, comprising the steps of:
a) preparing nanoparticulate cores consisting of a ruthenium compound,
b) coating the nanoparticulate ruthenium cores prepared in step a) with a silicate layer,
c) further coating the particles obtained in step b) with a shell of porous zirconium oxide or titanium oxide,
d) removing the silicate layer from the particles obtained in step c) using an alkali.

8. The process as claimed in claim 7, wherein said ruthenium compound is selected from the group consisting of ruthenium oxides, ruthenium-carbonyl complexes, ruthenium salts of inorganic acids, ruthenium-nitrosyl complexes, ruthenium-amine complexes and mixtures thereof.

9. The process as claimed in claim 7, wherein the further coating in step c) is effected by hydrolysis of at least one zirconium oxide shell precursor or titanium oxide shell precursor.

10. The process as claimed in claim 7, wherein the catalyst from step d) of the process is processed further to shaped bodies in the form of spheres, rings, trilobe or tetralobe stars, tablets, cylinders or wagon wheels, by pressing, spray drying and/or extruding.

11. (canceled)

12. A process for preparing chlorine from hydrogen chloride, performed in the presence of a catalyst comprising a nanoparticulate core consisting of a ruthenium compound with a surrounding gas- and liquid-pervious shell of zirconium oxide or titanium oxide.

13. The process as claimed in claim 12, performed at temperatures above 250° C.

14. The catalyst of claim 2, wherein said particle size distribution is 0.3 to 70 nm.

15. The catalyst of claim 12, wherein said particle size distribution is 0.5 to 40 nm.

16. The catalyst of claim 4, wherein said internal diameter is from 15 to 500 nm.

17. The catalyst of claim 16, wherein said internal diameter is from 20 to 300 nm.

18. The catalyst of claim 5, wherein said layer thickness is from 15 to 80 nm.

18. The catalyst of claim 18, wherein said layer thickness is from 15 to 40 nm.

19. The process of claim 13, performed at temperatures above 350° C.

20. The process of claim 19, performed at temperatures above 450° C.
